(19) United States
(12) Patent Application Publication
(10) Pub. No.: US 2026/0007488 A1
(43) Pub. Date: Jan. 8, 2026

(54) ORTHODONTIC TREATMENT EVALUATION

(71) Applicant: Brius Technologies, Inc., Carrollton, TX (US)

(72) Inventors: Woojae Kim, Dallas, TX (US); Mahdi Moradi, Dallas, TX (US); Seyed Mehdi Roein Peikar, Carrollton, TX (US); James Sylvester Wratten, Jr., Waterville, NY (US)

(21) Appl. No.: 18/992,863

(22) PCT Filed: Jul. 12, 2023
(86) PCT No.: PCT/US2023/070088

§ 371 Date: Jan. 9, 2025

Related U.S. Application Data
(60) Provisional application No. 63/368,216, filed on Jul. 12, 2022.
(60) Provisional application No. 63/380,349, filed on Oct. 20, 2022.

(51) Int. Cl. A61C 7/00; A61C 13/34; G06T 19/20

(52) U.S. Cl. CPC A61C 7/002; A61C 13/34; G06T 19/20; G06T 2210/41; G06T 2219/2004

(57) ABSTRACT

Devices, systems, and methods for orthodontic treatment, orthodontic treatment planning, and orthodontic treatment evaluation are disclosed herein. Various embodiments of the present technology, for example, are directed to a method of obtaining a plurality of digital models representing a patient's teeth in a variety of arrangements and displaying the digital models to an operator such as an orthodontist, a patient, etc. In some embodiments, the arrangements of the patient's teeth can comprise a predicted arrangement and/or an actual arrangement. Various embodiments of the present technology relate to creating a more realistic final arrangement of a patient's teeth based on actual positions of brackets on the patient's teeth. Some embodiments relate to displaying two or more digital models of unique tooth and/or bracket arrangements to an operator via a graphical user interface to facilitate evaluation of the tooth and/or bracket arrangements.

### CROSS-REFERENCE TO RELATED APPLICATION(S)

The present application claims the benefit of priority to U.S. Provisional Patent Application No. 63/368,216, filed Jul. 12, 2022, and U.S. Provisional Patent Application No. 63/380,349, filed Oct. 20, 2022, each of which is incorporated by reference herein in its entirety.

### TECHNICAL FIELD

The present technology relates to orthodontic treatment planning and associated devices, systems, and methods.

### BACKGROUND

A common objective in orthodontics is to move a patient's teeth to positions where the teeth function optimally and aesthetically. To move the teeth, the orthodontist begins by obtaining multiple scans and/or impressions of the patient's teeth to determine a series of corrective paths between the initial positions of the teeth and the desired ending positions. The orthodontist then fits the patient to one of two main appliance types: braces or aligners.

Traditional braces consist of brackets and an archwire placed across a front side of the teeth, with elastic ties or ligature wires to secure the archwire to the brackets. In some cases self-ligating brackets may be used in lieu of ties or wires. The shape and stiffness of the archwire as well as the archwire-bracket interaction governs the forces applied to the teeth and thus the direction and degree of tooth movement. To exert a desired force on the teeth, the orthodontist often manually bends the archwire. The orthodontist monitors the patient's progress through regular appointments, during which the orthodontist visually assesses the progress of the treatment and makes manual adjustments to the archwire (such as new bends) and/or replaces or repositions brackets. The adjustment process is both time consuming and tedious for the patient and more often than not results in patient discomfort for several days following the appointment. Moreover, braces are not aesthetically pleasing and make brushing, flossing, and other dental hygiene procedures difficult.

Aligners comprise clear, removable, polymeric shells having cavities shaped to receive and reposition teeth to produce a final tooth arrangement. Aligners offer patients significantly improved aesthetics over braces. Aligners do not require the orthodontists to bend wires or reposition brackets and are generally more comfortable than braces. However, unlike braces, aligners cannot effectively treat all malocclusions. Certain tooth repositioning steps, such as extrusion, translation, and certain rotations, can be difficult or impossible to achieve with aligners. Moreover, because the aligners are removable, success of treatment is highly dependent on patient compliance, which can be unpredictable and inconsistent.

Lingual braces are an alternative to aligners and traditional (buccal) braces and have been gaining popularity in recent years. Two examples of existing lingual braces are the Incognito™ Appliance System (3M United States) and INBRACE® (Swift Health Systems, Irvine, California, USA), each of which consists of brackets and an archwire placed on the lingual, or tongue side, of the teeth. In contrast to traditional braces, lingual braces are virtually invisible, and, unlike aligners, lingual braces are fixed to the patient's teeth and force compliance. These existing lingual technologies, however, also come with several disadvantages. Most notably, conventional lingual appliances still rely on a bracket-archwire system to move the teeth, thus requiring multiple office visits and painful adjustments. For example, lingual technologies have a relatively short inter-bracket distance, which generally makes compliance of the archwire stiffer. As a result, the overall lingual appliance is more sensitive to archwire adjustments and causes more pain for the patient. Moreover, the lingual surfaces of the appliance can irritate the tongue and impact speech, and make the appliance difficult to clean.

Therefore, a need exists for improved orthodontic appliances and methods of treatment planning.

### SUMMARY

Various embodiments of the present technology are directed to digital orthodontic treatment planning. The subject technology is illustrated, for example, according to various aspects described below, including with reference to FIGS. 1-26C. Various examples of aspects of the subject technology are described as numbered examples (1, 2, 3, etc.) for convenience. These are provided as examples and do not limit the subject technology.
1. A method comprising:
   creating a first digital model representing a patient's teeth in original positions, prior to an orthodontic intervention;
   creating a second digital model representing the patient's teeth in planned positions, prior to the orthodontic intervention;
   at a time after initiation of the orthodontic intervention, creating a third digital model representing the patient's teeth in current positions; and
   displaying, via a display device, an image of the first, second, and third digital models overlaid on one another.
2. A method comprising:
   creating a first digital model representing a patient's teeth in original positions with orthodontic brackets on the patient's teeth in intended positions relative to the patient's teeth;
   creating a second digital model representing the patient's teeth in planned positions with the orthodontic brackets on the patient's teeth in the intended positions relative to the patient's teeth;
   creating a third digital model representing the patient's teeth in current positions with the orthodontic brackets on the patient's teeth in actual positions relative to the patient's teeth; and
   displaying, via a display device, an image of the first, second, and third digital models overlaid on one another.
3. A method comprising:
   creating a first digital model representing a patient's teeth in original positions with orthodontic brackets on the patient's teeth in intended positions relative to the patient's teeth;
   creating a second digital model representing the patient's teeth in planned positions with the orthodontic brackets on the patient's teeth in the intended positions relative to the patient's teeth;
   creating a third digital model representing the patient's teeth in current positions with the orthodontic brackets on the patient's teeth in actual positions relative to the patient's teeth;
   obtaining positional differences between the actual positions and the intended positions of the orthodontic brackets; and
   based at least in part on the positional differences, creating a fourth digital model representing the patient's teeth in realistic planned positions with the orthodontic brackets on the patient's teeth in the actual positions relative to the patient's teeth.
4. The method of Example 3, wherein each of the positional differences between the actual positions and the intended positions of the orthodontic brackets comprises a transformation matrix.
5. The method of Example 3 or Example 4, wherein creating the fourth digital model comprises applying an inverse of the transformation matrix to the planned positions.
6. The method of any one of Examples 3 to 5, wherein the actual positions of the orthodontic brackets in the fourth digital model substantially correspond to the intended positions of the orthodontic brackets in the second digital model.
7. The method of any one of Examples 3 to 6, wherein obtaining each one of the positional differences comprises registering one of the patient's teeth and a respective one of the orthodontic brackets on the one of the patient's teeth from the third digital model to a corresponding one of the patient's teeth from the first digital model or the second digital model.
8. The method of Example 7, wherein registering one of the patient's teeth and the respective one of the orthodontic brackets on the one of the patient's teeth from the third digital model to the corresponding one of the patient's teeth in the first digital model or the second digital model comprises determining a transformation that, when applied to the one of the patient's teeth and the respective one of the orthodontic brackets on the one of the patient's teeth from the third digital model, reduces an error parameter characterizing a positional difference between the one of the patient's teeth from the third digital model and the corresponding one of the patient's teeth from the first digital model or the second digital model.
9. The method of any one of Examples 3 to 8, wherein obtaining each one of the positional differences comprises registering one of the patient's teeth and a respective one of the orthodontic brackets on the one of the patient's teeth from the first digital model or the second digital model to a corresponding one of the patient's teeth from the third digital model.
10. The method of Example 9, wherein registering one of the patient's teeth and the respective one of the orthodontic brackets on the one of the patient's teeth from the first digital model or the second digital model to the corresponding one of the patient's teeth in the third digital model comprises determining a transformation that, when applied to the one of the patient's teeth and the respective one of the orthodontic brackets on the one of the patient's teeth from the first digital model or the second digital model, reduces an error parameter characterizing a positional difference between the one of the patient's teeth from the first digital model or the second digital model and the corresponding one of the patient's teeth from the third digital model.
11. The method of Example 8 or Example 10, wherein the error parameter characterizes the positional difference between a first point on a crown of the one of the patient's teeth from the first digital model or the second digital model and a second point on the crown of the one of the patient's teeth from the third digital model.
12. The method of Example 8, Example 10, or Example 11, wherein the error parameter characterizes the positional difference between a first point on a root of the one of the patient's teeth from the first digital model or the second digital model and a second point on the root of the one of the patient's teeth from the third digital model.
13. The method of any one of Examples 3 to 12, wherein, if one of the actual positions of one of the orthodontic brackets is more apical than a corresponding one of the intended positions of the one of the orthodontic brackets relative to a corresponding one of the patient's teeth, a corresponding one of the revised planned positions of the corresponding one of the patient's teeth is extruded relative to a corresponding one of the planned positions of the one of the patient's teeth.
14. The method of any one of Examples 3 to 13, wherein, if one of the actual positions of one of the orthodontic brackets is more occlusal than a corresponding one of the intended positions of the one of the orthodontic brackets relative to a corresponding one of the patient's teeth, a corresponding one of the revised planned positions of the corresponding one of the patient's teeth is intruded relative to a corresponding one of the planned positions of the one of the patient's teeth.
15. The method of any one of Examples 3 to 14, wherein, if one of the actual positions of one of the orthodontic brackets is more mesial than a corresponding one of the intended positions of the one of the orthodontic brackets relative to a corresponding one of the patient's teeth, a corresponding one of the revised planned positions of the corresponding one of the patient's teeth is distal relative to a corresponding one of the planned positions of the one of the patient's teeth.
16. The method of any one of Examples 3 to 15, wherein, if one of the actual positions of one of the orthodontic brackets is more distal than a corresponding one of the intended positions of the one of the orthodontic brackets relative to a corresponding one of the patient's teeth, a corresponding one of the revised planned positions of the corresponding one of the patient's teeth is mesial relative to a corresponding one of the planned positions of the one of the patient's teeth.
17. The method of any one of Examples 3 to 16, wherein, if one of the actual positions of one of the orthodontic brackets is more rotated about a buccolingual dimension than a corresponding one of the intended positions of the one of the orthodontic brackets relative to a corresponding one of the patient's teeth, a corresponding one of the revised planned positions of the corresponding one of the patient's teeth is tipped relative to a corresponding one of the planned positions of the one of the patient's teeth.
18. The method of any one of Examples 3 to 17, wherein, if one of the actual positions of one of the orthodontic brackets is more rotated about a mesiodistal dimension than a corresponding one of the intended positions of the one of the orthodontic brackets relative to a corresponding one of the patient's teeth, a corresponding one of the revised planned positions of the corresponding one of the patient's teeth is torqued relative to a corresponding one of the planned positions of the one of the patient's teeth.
19. The method of any one of Examples 3 to 18, wherein, if one of the actual positions of one of the orthodontic brackets is more rotated about an occlusogingival dimension of the one of the orthodontic brackets than a corresponding one of the intended positions of the one of the orthodontic brackets, a corresponding one of the revised planned positions of a corresponding one of the patient's teeth is rotated about the occlusogingival dimension relative to a corresponding one of the planned positions of the one of the patient's teeth.
20. A method comprising:
   displaying to a user via a graphical user interface of a computing device:
      an original tooth arrangement (OTA) digital model characterizing original positions of a patient's teeth;
      a planned tooth arrangement (PTA) digital model characterizing planned positions of the patient's teeth; and
      an actual tooth arrangement (ATA) digital model characterizing actual positions of the patient's teeth.
21. The method of Example 20, wherein the OTA digital model, the PTA digital model, and the ATA digital model are superimposed on one another.
22. The method of Example 20 or Example 21, wherein at least one of the OTA digital model, the PTA digital model, or the ATA digital model characterizes orthodontic brackets positioned on the patient's teeth.
23. The method of Example 22, wherein at least one of the OTA digital model, the PTA digital model, or the ATA digital model characterizes the orthodontic brackets in intended positions on the patient's teeth.
24. The method of Example 22, wherein the at least one of the OTA digital model, the PTA digital model, or the ATA digital model characterizes the orthodontic brackets in actual positions on the patient's teeth.
25. The method of any one of Examples 20 to 24, wherein the PTA digital model characterizes planned positions of the patient's teeth based on intended positions of orthodontic brackets on the patient's teeth.
26. The method of any one of Examples 20 to 25, wherein the PTA digital model characterizes planned positions of the patient's teeth based on actual positions of orthodontic brackets on the patient's teeth.
27. The method of any one of Examples 20 to 26, wherein each of the OTA digital model, the PTA digital model, and the ATA digital model is displayed in a unique color.
28. The method of any one of Examples 20 to 27, wherein at least one of the OTA digital model, the PTA digital model, or the ATA digital model is displayed as at least partially transparent.
29. A computer-readable medium storing instructions that, when executed by a computing system having a memory and a processor, cause the computing system to perform a method comprising:
   creating a first digital model representing a patient's teeth in original positions, prior to an orthodontic intervention;
   creating a second digital model representing the patient's teeth in planned positions, prior to the orthodontic intervention;
   at a time after initiation of the orthodontic intervention, creating a third digital model representing the patient's teeth in current positions; and
   displaying, via a display device, an image of the first, second, and third digital models overlaid on one another.
30. A computer-readable medium storing instructions that, when executed by a computing system having a memory and a processor, cause the computing system to perform a method comprising:
   creating a first digital model representing a patient's teeth in original positions with orthodontic brackets on the patient's teeth in intended positions relative to the patient's teeth;
   creating a second digital model representing the patient's teeth in planned positions with the orthodontic brackets on the patient's teeth in the intended positions relative to the patient's teeth;
   creating a third digital model representing the patient's teeth in current positions with the orthodontic brackets on the patient's teeth in actual positions relative to the patient's teeth; and
   displaying, via a display device, an image of the first, second, and third digital models overlaid on one another.
31. A computer-readable medium storing instructions that, when executed by a computing system having a memory and a processor, cause the computing system to perform a method comprising:
   creating a first digital model representing a patient's teeth in original positions with orthodontic brackets on the patient's teeth in intended positions relative to the patient's teeth;
   creating a second digital model representing the patient's teeth in planned positions with the orthodontic brackets on the patient's teeth in the intended positions relative to the patient's teeth;
   creating a third digital model representing the patient's teeth in current positions with the orthodontic brackets on the patient's teeth in actual positions relative to the patient's teeth;
   obtaining positional differences between the actual positions and the intended positions of the orthodontic brackets; and
   based at least in part on the positional differences, creating a fourth digital model representing the patient's teeth in realistic planned positions with the orthodontic brackets on the patient's teeth in the actual positions relative to the patient's teeth.
32. The computer-readable medium of Example 31, wherein each of the positional differences between the actual positions and the intended positions of the orthodontic brackets comprises a transformation matrix.
33. The computer-readable medium of Example 32, wherein creating the fourth digital model comprises applying an inverse of the transformation matrix to the planned positions.
34. The computer-readable medium of Example 31, wherein the actual positions of the orthodontic brackets in the fourth digital model substantially correspond to the intended positions of the orthodontic brackets in the second digital model.
35. The computer-readable medium of Example 31, wherein obtaining each one of the positional differences comprises registering one of the patient's teeth and a respective one of the orthodontic brackets on the one of the patient's teeth from the third digital model to a corresponding one of the patient's teeth from the first digital model or the second digital model.
36. The computer-readable medium of Example 35, wherein registering one of the patient's teeth and the respective one of the orthodontic brackets on the one of the patient's teeth from the third digital model to the corresponding one of the patient's teeth in the first digital model or the second digital model comprises determining a transformation that, when applied to the one of the patient's teeth and the respective one of the orthodontic brackets on the one of the patient's teeth from the third digital model, reduces an error parameter characterizing a positional difference between the one of the patient's teeth from the third digital model and the corresponding one of the patient's teeth from the first digital model or the second digital model.
37. The computer-readable medium of Example 31, wherein obtaining each one of the positional differences comprises registering one of the patient's teeth and a respective one of the orthodontic brackets on the one of the patient's teeth from the first digital model or the second digital model to a corresponding one of the patient's teeth from the third digital model.
38. The computer-readable medium of Example 37, wherein registering one of the patient's teeth and the respective one of the orthodontic brackets on the one of the patient's teeth from the first digital model or the second digital model to the corresponding one of the patient's teeth in the third digital model comprises determining a transformation that, when applied to the one of the patient's teeth and the respective one of the orthodontic brackets on the one of the patient's teeth from the first digital model or the second digital model, reduces an error parameter characterizing a positional difference between the one of the patient's teeth from the first digital model or the second digital model and the corresponding one of the patient's teeth from the third digital model.
39. The computer-readable medium of Example 36 or Example 38, wherein the error parameter characterizes the positional difference between a first point on a crown of the one of the patient's teeth from the first digital model or the second digital model and a second point on the crown of the one of the patient's teeth from the third digital model.
40. The computer-readable medium of Example 36, Example 38, or Example 39, wherein the error parameter characterizes the positional difference between a first point on a root of the one of the patient's teeth from the first digital model or the second digital model and a second point on the root of the one of the patient's teeth from the third digital model.
41. The computer-readable medium of Example 31, wherein, if one of the actual positions of one of the orthodontic brackets is more apical than a corresponding one of the intended positions of the one of the orthodontic brackets relative to a corresponding one of the patient's teeth, a corresponding one of the revised planned positions of the corresponding one of the patient's teeth is extruded relative to a corresponding one of the planned positions of the one of the patient's teeth.
42. The computer-readable medium of Example 31, wherein, if one of the actual positions of one of the orthodontic brackets is more occlusal than a corresponding one of the intended positions of the one of the orthodontic brackets relative to a corresponding one of the patient's teeth, a corresponding one of the revised planned positions of the corresponding one of the patient's teeth is intruded relative to a corresponding one of the planned positions of the one of the patient's teeth.
43. The computer-readable medium of Example 31, wherein, if one of the actual positions of one of the orthodontic brackets is more mesial than a corresponding one of the intended positions of the one of the orthodontic brackets relative to a corresponding one of the patient's teeth, a corresponding one of the revised planned positions of the corresponding one of the patient's teeth is distal relative to a corresponding one of the planned positions of the one of the patient's teeth.
44. The computer-readable medium of Example 31, wherein, if one of the actual positions of one of the orthodontic brackets is more distal than a corresponding one of the intended positions of the one of the orthodontic brackets relative to a corresponding one of the patient's teeth, a corresponding one of the revised planned positions of the corresponding one of the patient's teeth is mesial relative to a corresponding one of the planned positions of the one of the patient's teeth.
45. The computer-readable medium of Example 31, wherein, if one of the actual positions of one of the orthodontic brackets is more rotated about a buccolingual dimension than a corresponding one of the intended positions of the one of the orthodontic brackets relative to a corresponding one of the patient's teeth, a corresponding one of the revised planned positions of the corresponding one of the patient's teeth is tipped relative to a corresponding one of the planned positions of the one of the patient's teeth.
46. The computer-readable medium of Example 31, wherein, if one of the actual positions of one of the orthodontic brackets is more rotated about a mesiodistal dimension than a corresponding one of the intended positions of the one of the orthodontic brackets relative to a corresponding one of the patient's teeth, a corresponding one of the revised planned positions of the corresponding one of the patient's teeth is torqued relative to a corresponding one of the planned positions of the one of the patient's teeth.
47. The computer-readable medium of Example 31, wherein, if one of the actual positions of one of the orthodontic brackets is more rotated about an occlusogingival dimension of the one of the orthodontic brackets than a corresponding one of the intended positions of the one of the orthodontic brackets, a corresponding one of the revised planned positions of a corresponding one of the patient's teeth is rotated about the occlusogingival dimension relative to a corresponding one of the planned positions of the one of the patient's teeth.
48. A computer-readable medium storing instructions that, when executed by a computing system having a memory and a processor, cause the computing system to perform a method comprising:
   displaying to a user via a graphical user interface of a computing device:
      an original tooth arrangement (OTA) digital model characterizing original positions of a patient's teeth;
      a planned tooth arrangement (PTA) digital model characterizing planned positions of the patient's teeth; and
      an actual tooth arrangement (ATA) digital model characterizing actual positions of the patient's teeth.
49. The computer-readable medium of Example 48, wherein the OTA digital model, the PTA digital model, and the ATA digital model are superimposed on one another.
50. The computer-readable medium of Example 48, wherein at least one of the OTA digital model, the PTA digital model, or the ATA digital model characterizes orthodontic brackets positioned on the patient's teeth.
51. The computer-readable medium of Example 50, wherein at least one of the OTA digital model, the PTA digital model, or the ATA digital model characterizes the orthodontic brackets in intended positions on the patient's teeth.
52. The computer-readable medium of Example 50, wherein the at least one of the OTA digital model, the PTA digital model, or the ATA digital model characterizes the orthodontic brackets in actual positions on the patient's teeth.
53. The computer-readable medium of Example 48, wherein the PTA digital model characterizes planned positions of the patient's teeth based on intended positions of orthodontic brackets on the patient's teeth.
54. The computer-readable medium of Example 48, wherein the PTA digital model characterizes planned positions of the patient's teeth based on actual positions of orthodontic brackets on the patient's teeth.
55. The computer-readable medium of Example 48, wherein each of the OTA digital model, the PTA digital model, and the ATA digital model is displayed in a unique color.
56. The computer-readable medium of Example 48, wherein at least one of the OTA digital model, the PTA digital model, or the ATA digital model is displayed as at least partially transparent.

### BRIEF DESCRIPTION OF THE DRAWINGS

Many aspects of the present disclosure can be better understood with reference to the following drawings. The components in the drawings are not necessarily to scale. Instead, emphasis is placed on illustrating clearly the principles of the present disclosure.

FIG. 1 illustrates an original tooth arrangement (OTA) digital model of a dental arch and an actual tooth arrangement (ATA) digital model of the dental arch superimposed on one another in accordance with the present technology.

FIG. 2 illustrates a planned final tooth arrangement (pFTA) digital model of the dental arch and the ATA digital model of the dental arch superimposed on one another in accordance with the present technology.

FIG. 3 illustrates the OTA digital model of the dental arch of FIG. 1, the pFTA digital model of the dental arch of FIG. 2, and the ATA digital model of the dental arch of FIGS. 1 and 2 superimposed on one another in accordance with the present technology.

FIG. 4 illustrates an OTA digital model of a dental arch with brackets in accordance with the present technology.

FIG. 5 illustrates a pFTA digital model of the digital model of the dental arch with brackets in accordance with the present technology.

FIG. 6 illustrates an rFTA digital model of the dental arch with brackets in accordance with the present technology.

FIG. 7 illustrates the OTA digital model of the dental arch of FIG. 4, the pFTA digital model of the dental arch of FIG. 5, and the rFTA digital model of the dental arch of FIG. 6 superimposed on one another in accordance with the present technology.

FIG. 8 illustrates an example of an OTA digital model of a dental arch with brackets in intended positions relative to the teeth and brackets in actual positions relative to the teeth in accordance with the present technology.

FIG. 9 illustrates an OTA digital model of both of a patient's dental arches in accordance with the present technology.

FIG. 10 illustrates a pFTA digital model of both of a patient's dental arches in accordance with the present technology.

FIG. 11 illustrates an ATA digital model of both of a patient's dental arches in accordance with the present technology.

FIG. 12 illustrates the OTA digital model of both of the patient's dental arches of FIG. 9 and the ATA digital model of both of the patient's dental arches of FIG. 11 superimposed on one another in accordance with the present technology.

FIG. 13 illustrates the pFTA digital model of both of the patient's dental arches of FIG. 10 and the ATA digital model of both of the patient's dental arches of FIG. 11 superimposed on one another in accordance with the present technology.

FIG. 14 illustrates the OTA digital model of both of the patient's dental arches of FIG. 9, the pFTA digital model of both of the patient's dental arches of FIG. 10, and the ATA digital model of both of the patient's dental arches of FIG. 11 superimposed on one another in accordance with the present technology.

FIG. 15 shows an example method for orthodontic treatment planning in accordance with several embodiments of the present technology.

FIG. 16 shows an example method for evaluating bracket positioning accuracy in accordance with several embodiments of the present technology.

FIGS. 17A and 17B schematically depict various concepts related to the method shown in FIG. 16 in accordance with the present technology.

FIGS. 18A-18C schematically depict various concepts related to the method shown in FIG. 16 in accordance with the present technology.

FIGS. 19A-19C schematically depict various concepts related to the method shown in FIG. 16 in accordance with the present technology.

FIGS. 20A and 2B schematically depict various concepts related to the method shown in FIG. 16 in accordance with the present technology.

FIG. 21 shows a method for generating an rFTA digital model based on bracket inaccuracies in accordance with several embodiments of the present technology.

FIGS. 22A-22D schematically depict various concepts related to the method shown in FIG. 21 in accordance with the present technology.

FIGS. 23A-23C schematically depict various concepts related to the method shown in FIG. 21 in accordance with the present technology.

FIG. 24 shows a method for modifying an SF fixture based on bracket inaccuracies in accordance with several embodiments of the present technology.

FIGS. 25A-22C schematically depict various concepts related to the method shown in FIG. 24 in accordance with the present technology.

FIGS. 26A-26C schematically depict various concepts related to the method shown in FIG. 24 in accordance with the present technology.

### DETAILED DESCRIPTION

Digital orthodontic treatment planning involves generating 3D digital models of a patient's dental anatomy (e.g., teeth, gums, jawbone, etc.), which can be used to determine planned movements of the patient's teeth to be accomplished by an orthodontic intervention (e.g., an appliance, aligners, elastics, mini-screws, surgery, etc.). The teeth can then be moved by the orthodontic intervention from original positions in which the teeth are misaligned and/or maloccluded to final positions in which the alignment and occlusion of the teeth are improved. Such treatment planning can facilitate the manufacturing of custom orthodontic appliances for moving the patient's teeth according to the planned movements.

During the digital orthodontic treatment planning process, a variety of digital models representing the patient's teeth can be generated by the systems of the present technology, including, for example, an original tooth arrangement (OTA) digital model virtually representing the teeth in original positions, a planned final tooth arrangement (pFTA) digital model virtually representing the teeth in planned, final positions, etc. Any of such digital models can include virtual representations of orthodontic brackets positioned on the patient's teeth at intended locations relative to the corresponding teeth.

The systems of the present technology are configured to obtain an actual tooth arrangement (ATA) digital model representing the patient's teeth after some or all of an orthodontic treatment has been implemented. The ATA digital model generated by the system can be compared to one or more digital models created during the treatment planning process (e.g., the OTA digital model, the pFTA digital model, etc.) to evaluate the accuracy and/or efficiency of an orthodontic treatment. As but one example, the systems of the present technology can compare one or more ATA digital models to the OTA digital model and/or the pFTA digital model to evaluate how far the teeth have moved from the original positions and/or whether the teeth have reached the desired, final positions. Moreover, if orthodontic brackets are secured to the patient's teeth at actual locations that differ from the intended locations, the forces applied to the teeth by an appliance secured to the brackets will differ than the intended forces, and the teeth may be moved to positions other than the desired, final positions. Thus, it can be useful to compare the ATA digital model and the OTA digital model and/or the pFTA digital model to assess how accurately the brackets were bonded to the patient's teeth. The evaluation can guide clinical training, further orthodontic treatments, and/or improvements in appliance designs.

Various embodiments of the present technology relate to creating a realistic final tooth arrangement (rFTA) digital model of a patient's teeth. As previously noted, in some cases orthodontic brackets may be secured to a patient's teeth in actual positions that differ from intended positions used during the treatment planning process. Such inaccuracies in bracket placement can cause the teeth to be moved by an orthodontic appliance to positions other than the planned, final positions. It can be useful to determine the realistic, final positions of the teeth that should be accomplished based on the actual positions of the brackets relative to the teeth. The rFTA digital model can be compared to the ATA digital model to evaluate how accurately the appliance moved the teeth.

Digital models of a patient's teeth can be displayed to a human operator via a graphical user interface (GUI), for example, or any display device. The operator, such as an orthodontist, an orthodontic assistant, a patient, an appliance manufacturer, etc., can view and/or manipulate the digital models in the graphical user interface to visualize various arrangements of the patient's teeth (e.g., original, planned, actual, etc.) and/or brackets secured to the teeth (e.g., intended, actual, etc.) to evaluate a proposed treatment, a recently completed treatment, etc.

In some embodiments, it can be useful to simultaneously display two or more digital models of a patient's teeth to an operator via a GUI to facilitate interpretation of the teeth positions and/or movements. The digital models can be displayed separately at the same time or superimposed on one another. Each digital model can be displayed with a unique color (e.g., a first digital model displayed with a first color, a second digital model displayed with a second color unique from the first color, etc.) to facilitate distinguishing the digital models from one another. Additionally or alternatively, a transparency of one or more of the digital models can be controlled by the operator to facilitate visualization of overlapping structures, for example.

A difference in position and/or shape between a tooth or a bracket in one digital model and the same tooth or bracket in another digital model can be identified and, optionally, can be communicated to the operator. In some cases, communicating the differences to an operator comprises color coding, highlighting, shading, or otherwise denoting the region where the difference occurs. For example, if a difference between a 3D position and orientation of a central incisor of a patient in the pFTA digital model and a 3D position and orientation of the central incisor in the rFTA digital model exceeds a predetermined threshold, the central incisor can be displayed with a unique color, pattern, outline, etc., and/or an alert can be displayed in the graphical user interface displaying text identifying the central incisor and/or the difference.

Superimposing two, three, or more digital models can comprise registering one of the digital models to the other of the digital models. In various embodiments, such a registration comprises identifying and applying a transformation that, when applied to one of the digital models, reduces or minimizes a distance between that digital model and another one of the digital models.

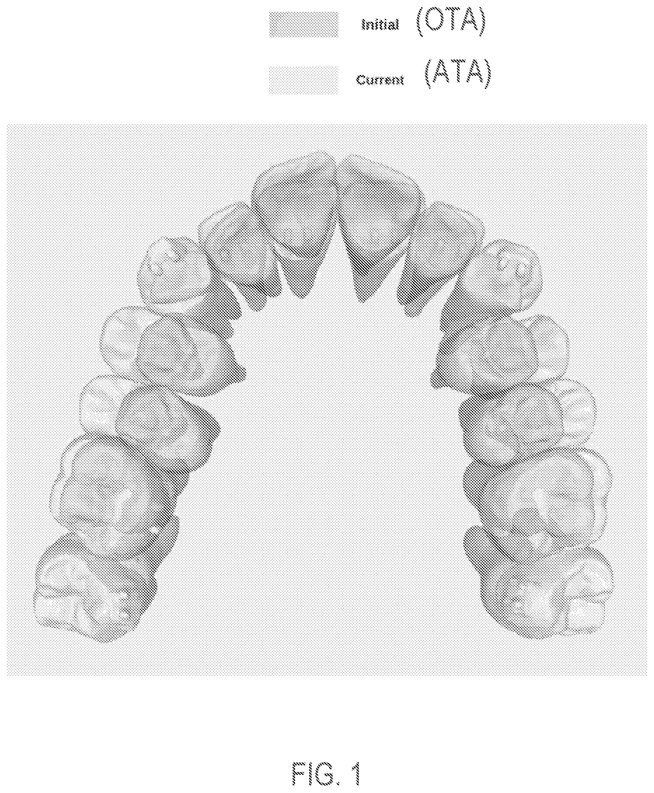

The systems of the present technology can be configured to generate an OTA digital model of a dental arch and an ATA digital model of the dental arch and superimpose the OTA digital model on the ATA digital model (or vice versa), as shown for example in FIG. 1. The system can be configured to display each of the OTA digital model and the ATA digital model with a unique color, opacity, shading, pattern, etc. to help distinguish between the digital models when superimposed. The OTA digital model can represent the teeth of the dental arch at their original positions (e.g., prior to implementation of some or all of an orthodontic treatment) and the ATA digital model can represent the teeth of the dental arch in their actual positions at the time that the ATA digital model and/or the underlying data was obtained. For example, the ATA digital model can represent the teeth in their actual positions some duration after an orthodontic treatment was initiated, after orthodontic treatment is completed, etc. As shown in FIG. 1, in some cases the actual positions of the teeth can differ from the original positions of the teeth. For example, if the ATA digital model is obtained after an orthodontic appliance has been secured to the patient's teeth, the ATA digital model will reflect any changes in positions of the teeth due to forces applied to the teeth by the orthodontic appliance. The teeth in the ATA digital model, for example as shown in FIG. 1, may be better aligned than the teeth in the OTA digital model. In some cases, the actual positions of the teeth can substantially correspond to the original positions of the teeth (e.g., if the ATA digital model is obtained prior to implementation of an orthodontic treatment, etc.).

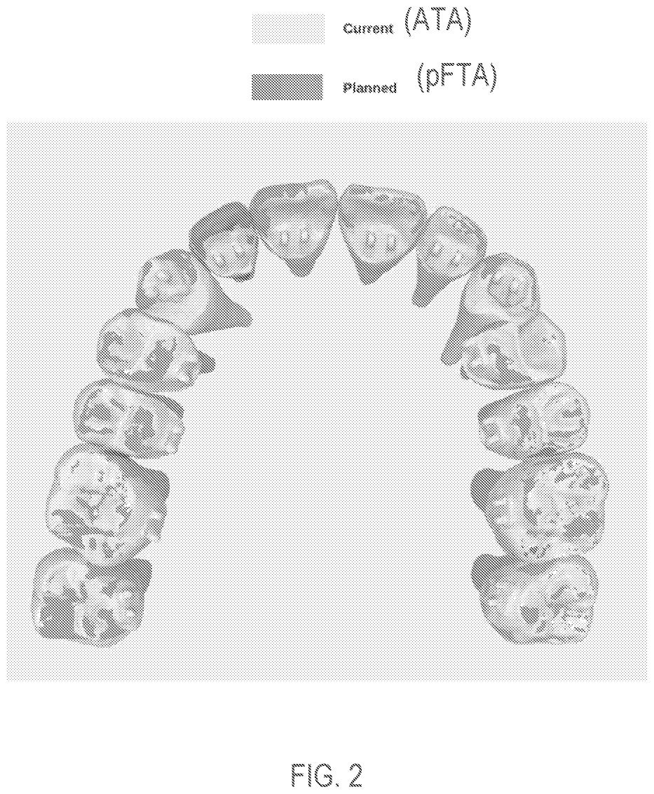

The systems of the present technology can be configured to generate a pFTA digital model of the dental arch and the ATA digital model of the dental arch and superimpose the pFTA digital model on the ATA digital model (or vice versa), for example as shown in FIG. 2. Each of the pFTA digital model and the ATA digital model can be displayed with a unique color, opacity, shading, pattern, etc. to help distinguish between the digital models. The pFTA digital model can represent the teeth of the dental arch at planned, final positions (e.g., in which the teeth are better aligned, after a planned orthodontic treatment, etc.). In various embodiments, the pFTA digital model can be obtained by moving the teeth from the OTA digital model into planned, final positions. As shown in FIG. 2, in some cases the actual positions of the teeth can differ from the planned, final positions of the teeth. For example, if an orthodontic treatment is incomplete and/or has moved the teeth to positions other than the planned, final positions (e.g., due to inaccurate appliance manufacturing, inaccurate bracket placement, biological variation, etc.), the actual positions may differ from the planned, final positions. The teeth in the ATA digital model, for example as shown in FIG. 2, may be insufficiently aligned relative to the teeth in the pFTA digital model.

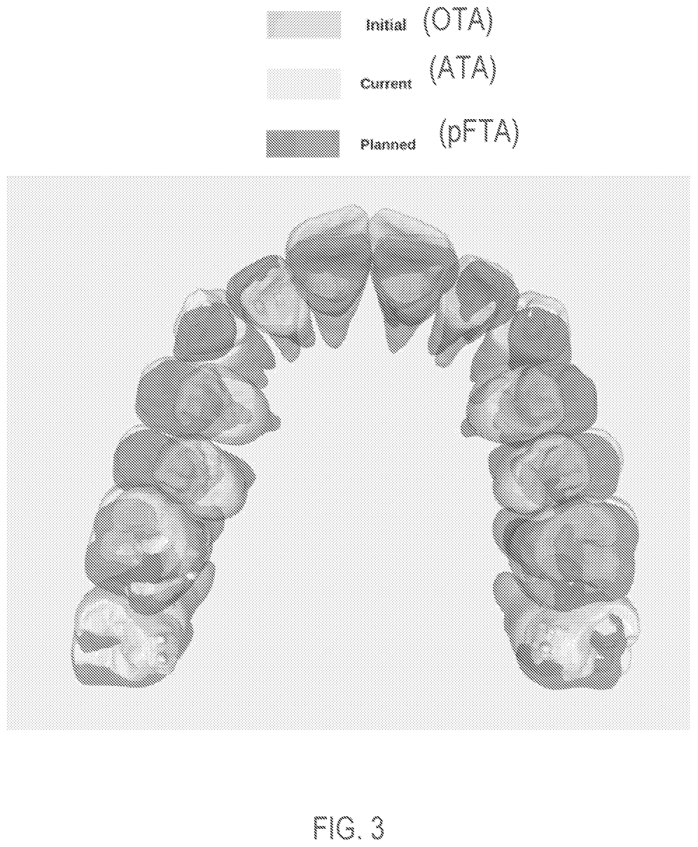

The systems of the present technology can be configured to overlay the OTA digital model, the ATA digital model, and the pFTA digital model. FIG. 3, for example, illustrates the OTA digital model of the dental arch of FIG. 1, the pFTA digital model of the dental arch of FIG. 2, and the ATA digital model of the dental arch of FIGS. 1 and 2 superimposed on one another. Displaying two or more digital models superimposed on one another can facilitate visualization of any differences in positions of the teeth. Moreover, displaying the OTA digital model, the pFTA digital model, and the ATA digital model overlaid on top of one another can communicate in a single visual how much the patient's teeth have moved from their original positions and how far they need to move to reach their planned, final positions.

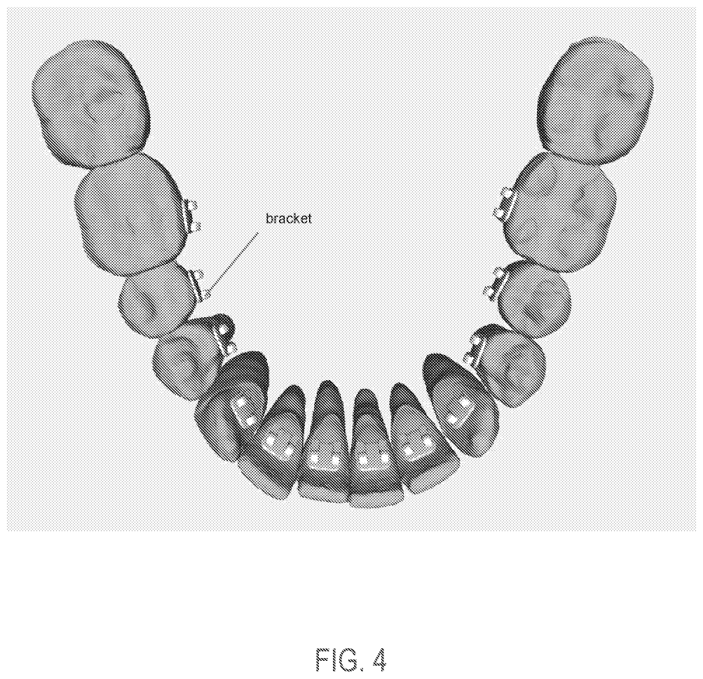

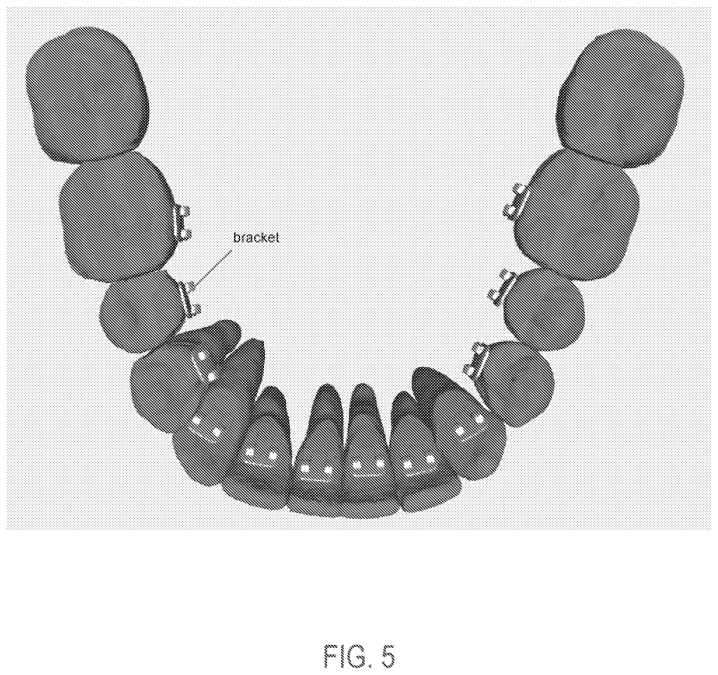

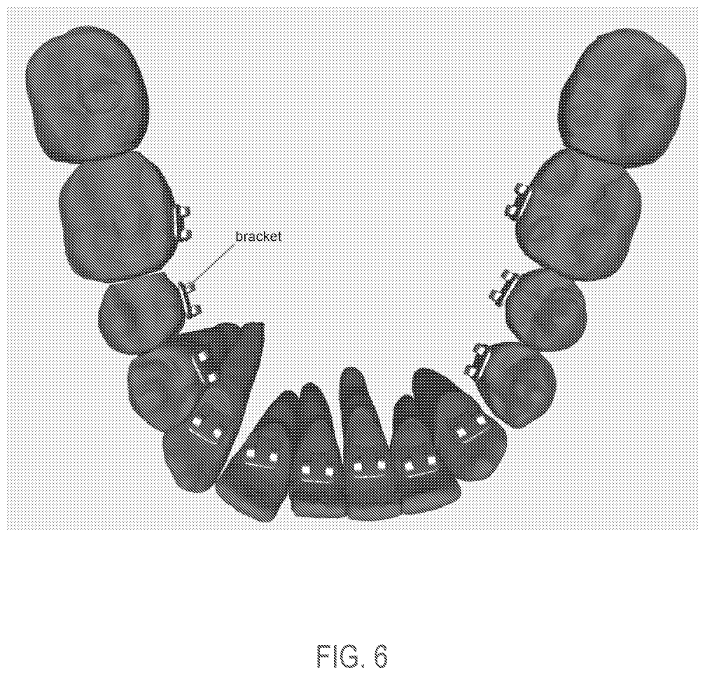

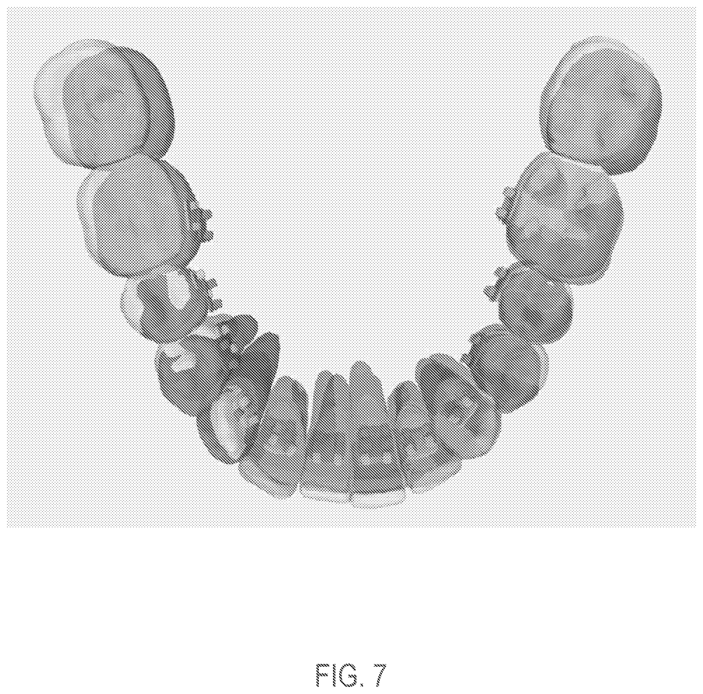

Although FIGS. 1-3 depict digital models of the teeth without orthodontic brackets, in some embodiments the system can display one or more of the digital models with brackets. For example, FIG. 4 illustrates an OTA digital model of a dental arch with brackets, FIG. 5 illustrates a pFTA digital model of the digital model of the dental arch with brackets, and FIG. 6 illustrates an rFTA digital model of the dental arch with brackets. FIG. 7 illustrates the OTA digital model of the dental arch of FIG. 4, the pFTA digital model of the dental arch of FIG. 5, and the rFTA digital model of the dental arch of FIG. 6 superimposed on one another in accordance with the present technology. The brackets can be shown in intended positions relative to the teeth, which can be determined manually by an operator and/or automatically by a software program during the treatment planning process. Additionally or alternatively, the brackets can be shown in actual positions relative to the teeth and representing the true positions of the brackets on the teeth after the brackets have been physically bonded to the teeth.

In some embodiments, it can be advantageous to evaluate the actual positions at which orthodontic brackets were bonded to a patient's teeth. Brackets can be bonded to a patient's teeth via an indirect bonding tray and/or via direct bonding. In any case, a bracket can be bonded to a patient's tooth at an actual position that differs from the intended position of the bracket relative to the patient's teeth. For example, errors in bracket positioning can occur because of defects in the bonding tray, human error, complex anatomy, and other reasons. The position of a bracket on a tooth can influence the magnitude and/or direction of a force applied to the tooth by an appliance via the bracket. As a result, the teeth may be moved by such an appliance to positions other than the planned, final positions. Accordingly, it can be useful to obtain an rFTA digital model characterizing the realistic, final positions of the patient's teeth based on the actual positions of the brackets relative to the patient's teeth. As shown in FIG. 7, the rFTA can differ from the pFTA if the actual positions of the brackets differ from the intended positions of the brackets.

Obtaining the rFTA digital model can comprise obtaining an ATA digital model representing the patient's teeth in current positions with the orthodontic brackets on the patient's teeth in actual positions relative to the patient's teeth and obtaining an OTA digital model representing the patient's teeth in original positions with the orthodontic brackets on the patient's teeth in intended positions relative to the patient's teeth and/or a pFTA digital model representing the patient's teeth in planned, final positions with the orthodontic brackets on the patient's teeth in the intended positions relative to the patient's teeth. In some embodiments, each tooth of the ATA digital model can be registered to a corresponding tooth of the OTA or pFTA digital model (or vice versa). Such a registration can comprise reducing or minimizing an error between the crown and/or root of the tooth in the ATA digital model and the crown and/or root of the tooth in the OTA or pFTA digital model. Next, obtaining the rFTA digital model can comprise obtaining positional differences characterizing the differences between the actual positions of the brackets from the ATA digital model and the intended positions of the brackets from the OTA digital model and/or the pFTA digital model. The pFTA digital model can be modified based on the positional differences to create the rFTA digital model. For example, a tooth in the pFTA digital model can be translated and/or rotated based on the corresponding positional difference of a corresponding bracket to create the rFTA digital model representing the tooth at a realistic, final position. In various embodiments, each positional difference can comprise a transformation matrix characterizing translations and rotations in six degrees of freedom that characterize the difference between the actual and intended positions of a bracket. Additionally or alternatively, a tooth in the pFTA can be moved according to an inverse of such a transformation matrix to obtain the realistic, final position of the tooth in the rFTA. In some embodiments, the brackets in the rFTA are located at the same positions in a global 3D coordinate system relative to the brackets in the pFTA.

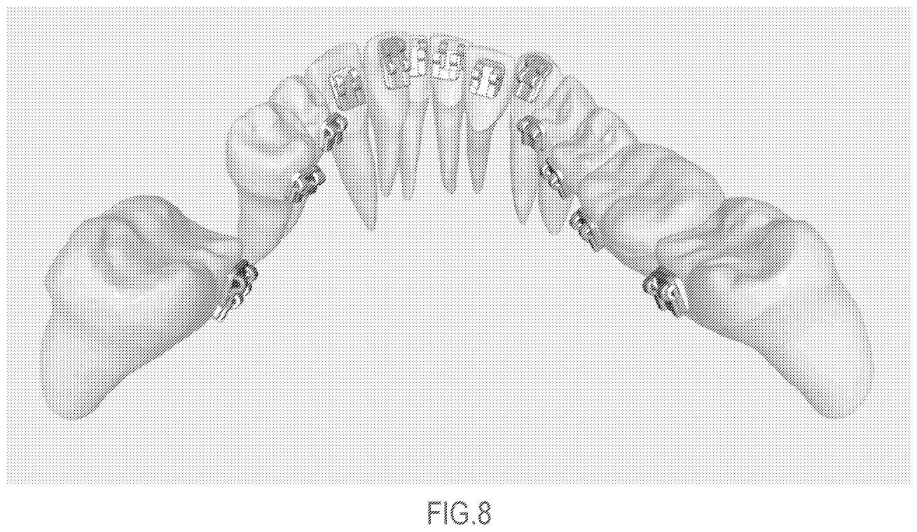

It can be useful to visualize differences between the actual positions of brackets relative to the patient's teeth and intended positions of the brackets relative to the patient's teeth. In some embodiments, a digital model of the patient's teeth can be displayed via a graphical user interface with brackets in their intended positions relative to the teeth and brackets in their actual positions relative to the teeth. FIG. 8 illustrates an example of an OTA digital model of a dental arch with brackets in intended positions relative to the teeth and brackets in actual positions relative to the teeth in accordance with the present technology.

While FIGS. 1-8 illustrate a digital model of one of a patient's dental arches, it can be useful to evaluate and/or display both of a patient's upper and lower dental arches. Some orthodontic treatments involve moving a patient's teeth according to overall movements, each comprising one or more component movements of one or more teeth. For example, the overall movements can comprise a movement that is unique to each tooth (e.g., an intraarch movement), a movement that is common to all of the teeth in one of the patient's dental arches (e.g., an interarch movement), a movement that is common to all of the teeth in both of the patient's dental arches, etc. Visualizing both of a patient's upper and lower dental arches simultaneously can facilitate interpretation of such component movements. Visualizing both of a patient's upper and lower dental arches in one arrangement (e.g., OTA, ATA, pFTA, IFTA, etc.) relative to the patient's upper and lower dental arches in another arrangement (e.g., OTA, ATA, pFTA, IFTA, etc.) can facilitate evaluating the magnitude and type of component movements that are planned, evaluating the magnitude and type of component movements that have been accomplished, etc.

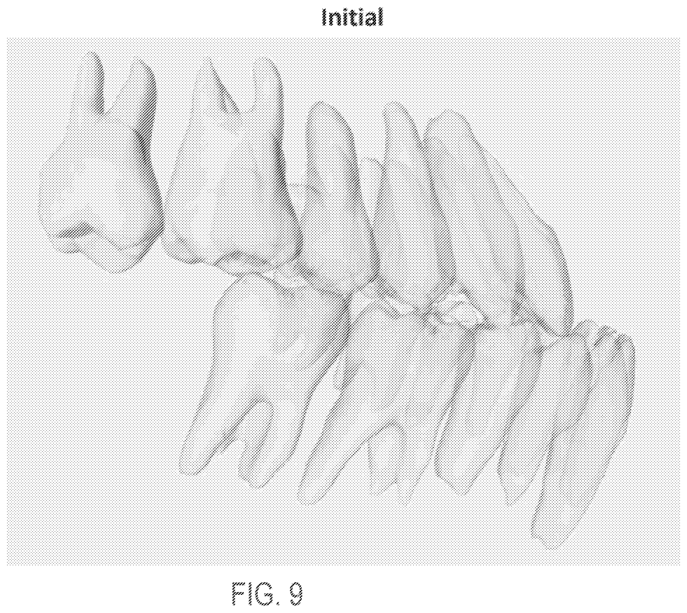

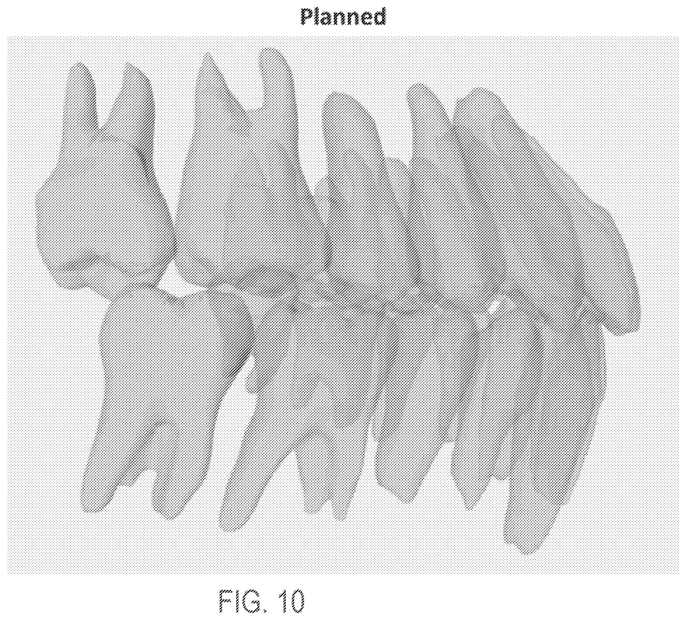

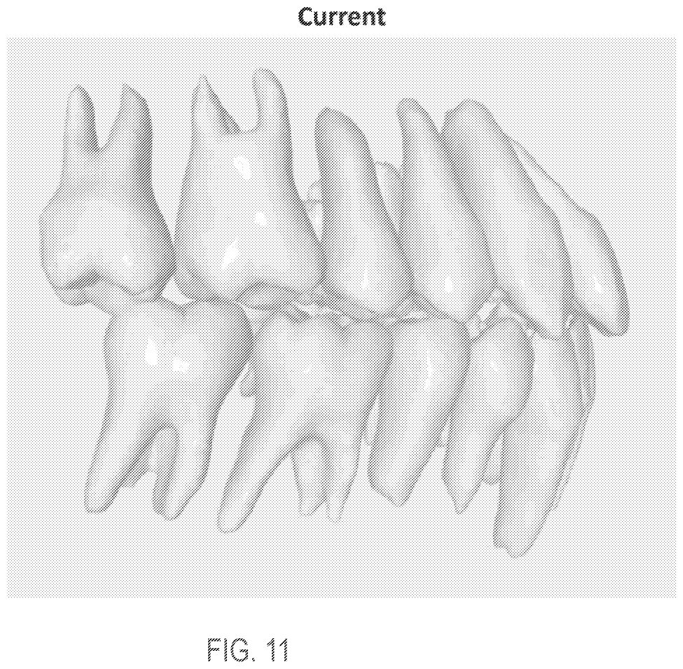

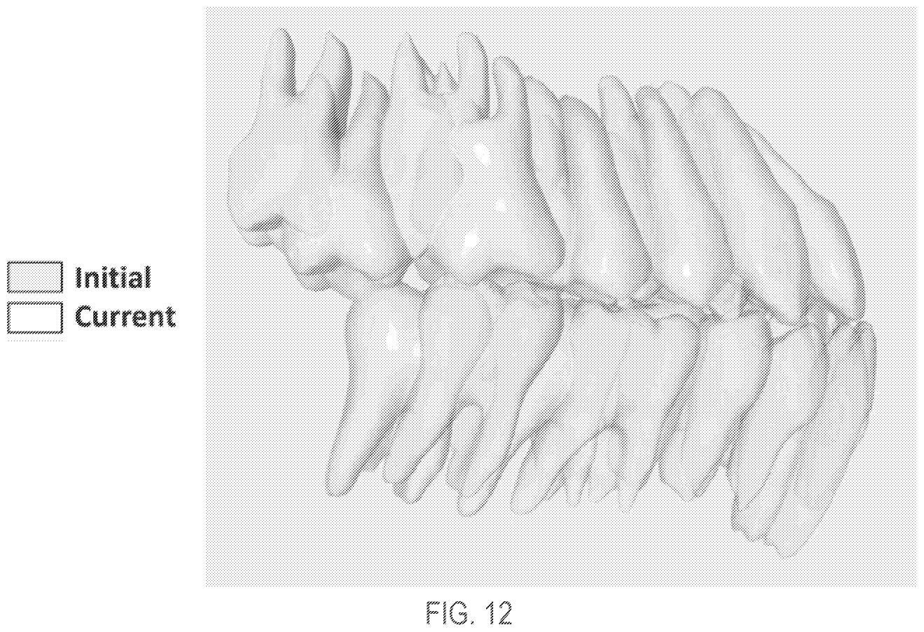

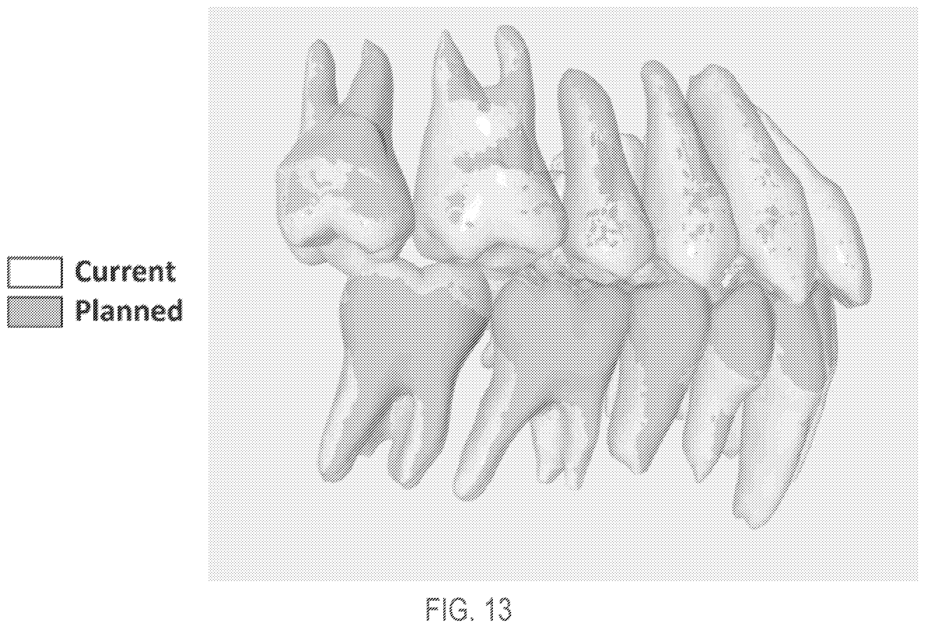

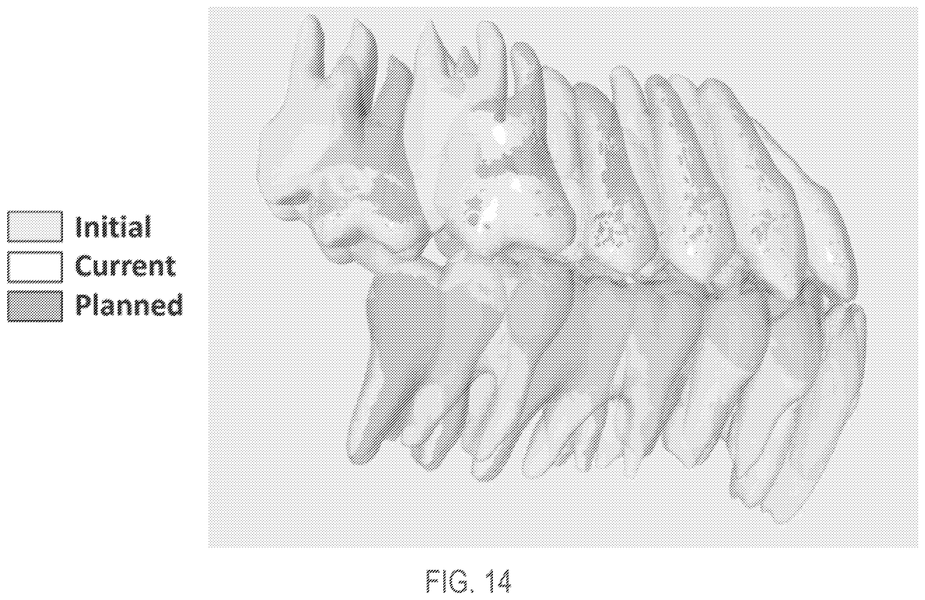

FIG. 9 illustrates an OTA digital model of both of a patient's dental arches in accordance with the present technology, FIG. 10 illustrates a pFTA digital model of both of a patient's dental arches in accordance with the present technology, and FIG. 11 illustrates an ATA digital model of both of a patient's dental arches in accordance with the present technology. FIG. 12 illustrates the OTA digital model of both of the patient's dental arches of FIG. 9 and the ATA digital model of both of the patient's dental arches of FIG. 11 superimposed on one another. The systems of the present technology are configured to display to a user the visual shown in FIG. 12. FIG. 13 illustrates the pFTA digital model of both of the patient's dental arches of FIG. 10 and the ATA digital model of both of the patient's dental arches of FIG. 11 superimposed on one another. The systems of the present technology are configured to display to a user the visual shown in FIG. 13. FIG. 14 illustrates the OTA digital model of both of the patient's dental arches of FIG. 9, the pFTA digital model of both of the patient's dental arches of FIG. 10, and the ATA digital model of both of the patient's dental arches of FIG. 11 superimposed on one another. The systems of the present technology are configured to display to a user the visual shown in FIG. 14.

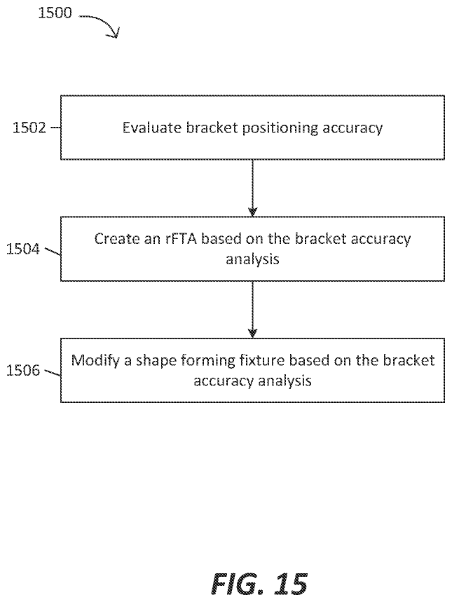

FIG. 15 shows an example method 1500 for digital orthodontic treatment planning in accordance with several embodiments of the present technology. The method 1500 can comprise evaluating bracket positioning accuracy (1502), creating an rFTA based on the bracket accuracy analysis (1504), and modifying a shape forming (SF) fixture based on the bracket accuracy analysis (1506).

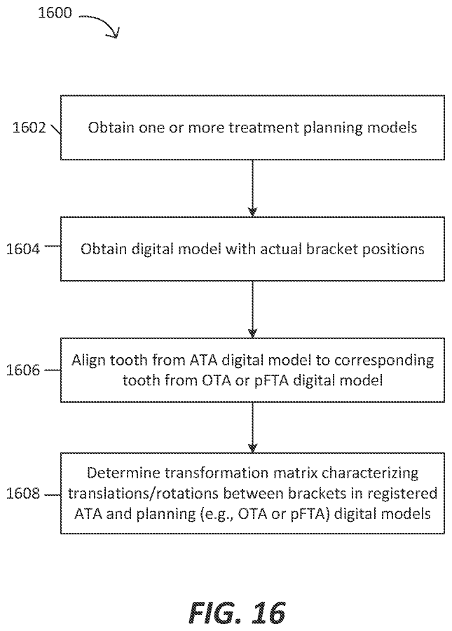

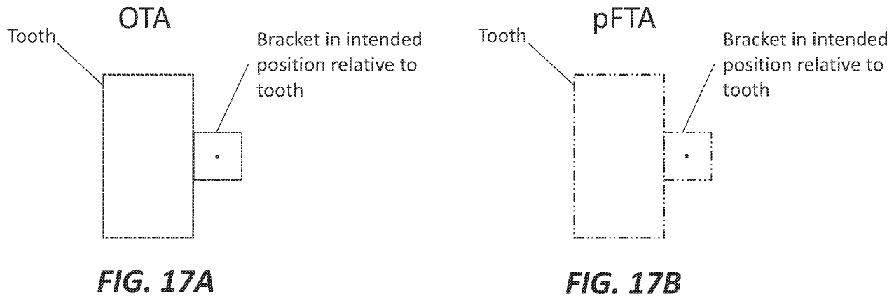

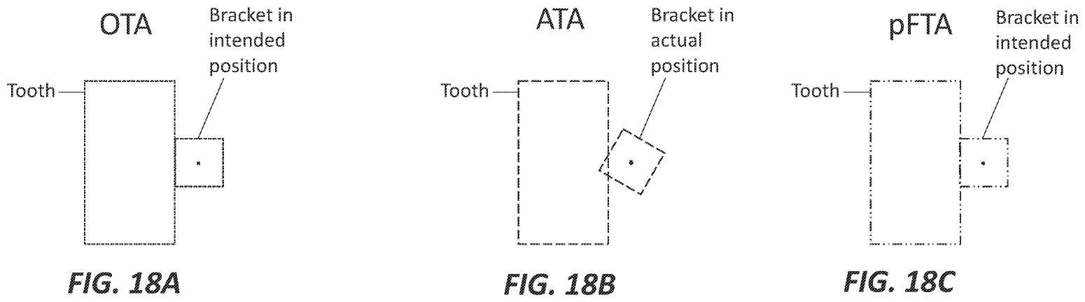

FIG. 16 shows an example method 1600 for evaluating bracket positioning accuracy. The method 1600 can comprise obtaining one or more treatment planning models (1602), which can include an OTA digital model and/or a pFTA digital model. The treatment planning model(s) can include one or more brackets located at intended positions relative to the corresponding teeth, as demonstrated schematically in FIGS. 17A and 17B. For ease of explanation, the schematics depicted in the drawings showing the determination of bracket inaccuracies and the creation of an rFTA are occlusal views of one tooth and one bracket. As shown in FIGS. 18A-18C, an ATA digital model can be obtained after the brackets have been bonded to the patient's teeth to obtain a digital model characterizing actual positions of the brackets relative to the corresponding teeth (1604).

The ATA digital model can be obtained after bonding the brackets and before manufacturing an appliance. Obtaining the ATA digital model before installing the appliance can allow the appliance design to be modified based on the actual bracket positions, for example as discussed herein with reference to modifying the SF fixture. In some cases, it may not be practical to delay treatment to modify an appliance design based on the actual bracket positions. Accordingly, the ATA digital model can be obtained after bonding the brackets and after installation of the appliance. In such embodiments and others, the information obtained about the bracket placement accuracy can be used to modify the design of a refinement appliance, provide feedback to clinicians bonding brackets, create and/or modify tools to facilitate bracket bonding, etc.

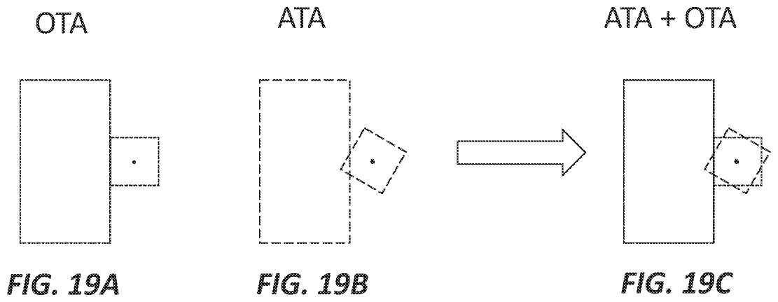

In some cases, such as that shown in FIGS. 18A-18C, an actual position of a bracket may differ from its intended position. To evaluate and quantify any differences between the actual and intended positions of the brackets, each tooth and its corresponding bracket in the ATA digital model can be compared to a respective tooth and corresponding bracket in one of the treatment planning models (e.g., the OTA digital model, the pFTA digital model, etc.). As shown in FIGS. 19A-19C, the crown and/or root of a tooth from the treatment planning model can be registered to the crown and/or root of the corresponding tooth from the ATA digital model, or vice versa (1606). Notably, this registration process involves aligning the crowns and/or roots of corresponding teeth but does not involve aligning the brackets of the corresponding teeth. To register a tooth in one digital model to a corresponding tooth in another digital model, a transformation can be calculated that minimizes or reduces a distance between the two teeth.

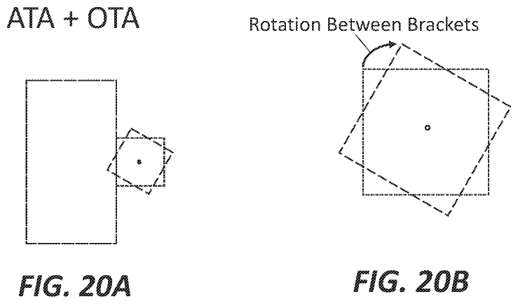

A comparison of the actual bracket positions to the intended bracket positions can be performed once corresponding pairs of teeth from the treatment planning model and the ATA digital model have been registered. A difference in position and orientation between an actual bracket position and an intended bracket position can be characterized as a transformation matrix (1608). For example, the difference can be characterized as a 4×4 transformation matrix that, when applied to the intended position of the bracket, provides the actual position of the bracket. FIGS. 20A and 20B show an example of a transformation comprising a rotation of 30 degrees clockwise from the solid bracket (ATA) to the dashed bracket (ATA) about the occlusogingival axis going through the black dot.

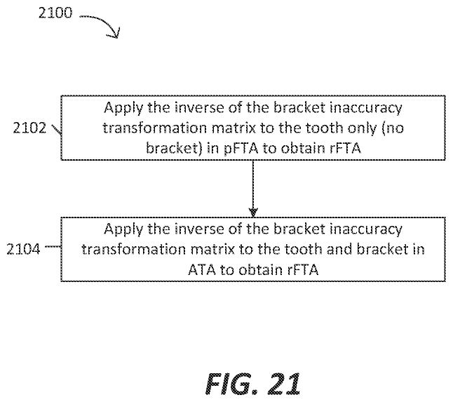

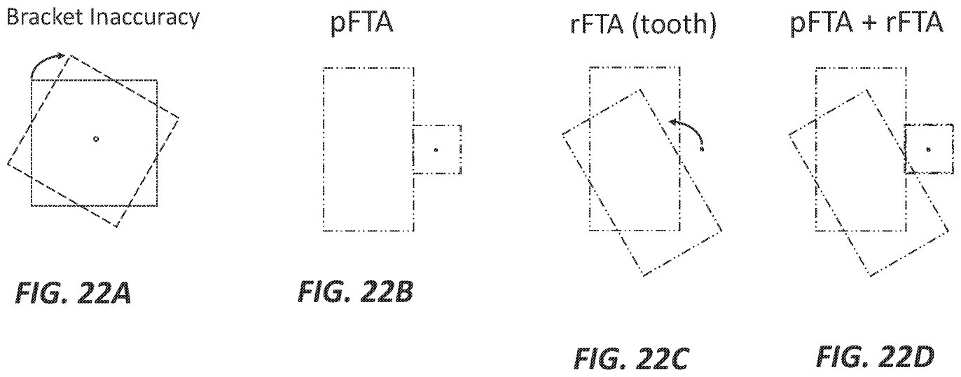

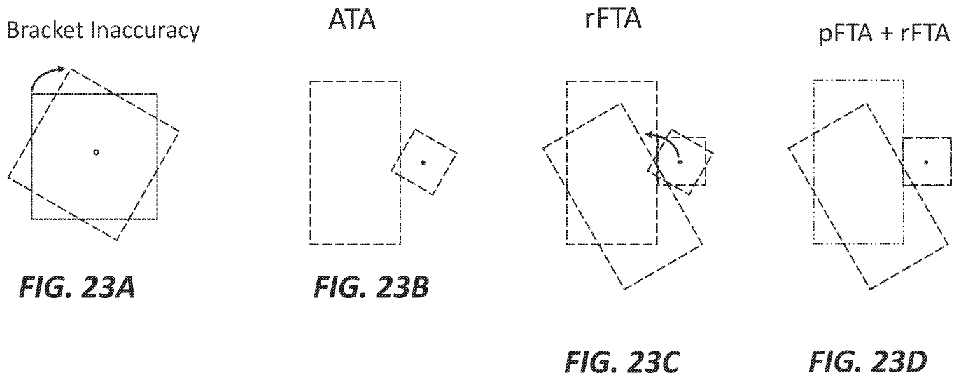

As previously noted, the differences in bracket positions can be used to generate an rFTA digital model. FIG. 21 shows a method 2100 for generating an IFTA digital model based on bracket inaccuracies in accordance with several embodiments of the present technology. As shown at block 2102 and depicted schematically in FIGS. 22A-22D, the rFTA digital model can be generated by applying an inverse of the transformation matrix characterizing a difference between an actual bracket position and an intended bracket position to one or more portions of the pFTA digital model and/or the ATA digital model. When applying the inverse of the transformation matrix to the pFTA digital model, the inverse transformation is applied to the respective tooth only and is not applied to the corresponding bracket. As a result, the bracket in the rFTA digital model will be in the same position as the bracket in the pFTA digital model. When an appliance is shape set with an SF fixture, the attachment portions (the portions configured to be secured to a bracket) of the appliance are set at the intended positions of the brackets. Accordingly, even if the actual bracket positions vary from the intended bracket positions, when the appliance is deformed and installed in the patient's mouth, it will return to its predetermined shape with the attachment portions and brackets at the intended bracket positions. However, if the actual positions of the brackets differ from the intended positions of the brackets, the teeth will not be aligned as expected. Thus, the systems of the present technology apply an inverse transformation to the tooth of the pFTA digital model but not the bracket so that the rFTA digital model reflects the brackets being located at the intended positions but the teeth being misaligned. Notably, the inverse transformation is applied to the tooth at a point at which the bracket inaccuracy was calculated (e.g., a center of mass of the bracket, a geometric center of the bracket, a datum of the bracket, etc.) to maintain a consistent axis of rotation. As shown in FIGS. 23A-23D, the rFTA digital model can be obtained from the ATA digital model by applying the inverse transformation to the respective tooth and bracket of the ATA digital model.

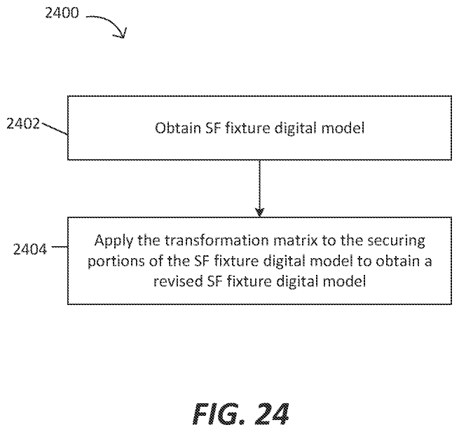

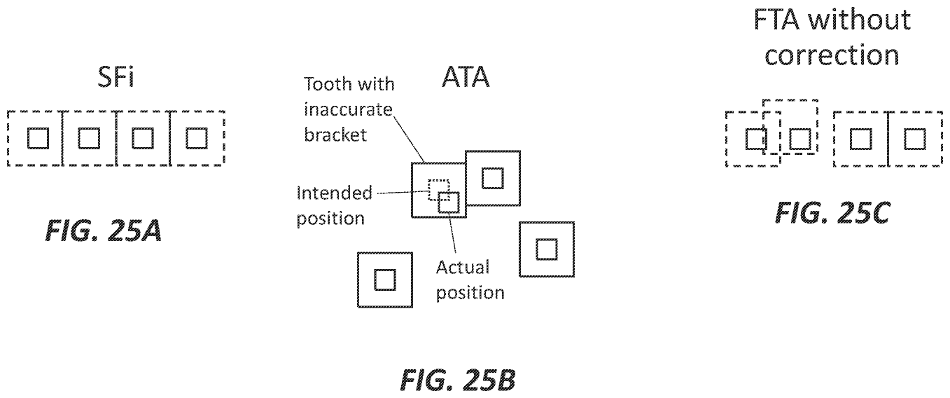

In some embodiments, it can be advantageous to modify an SF fixture for setting a shape of an appliance based on the actual bracket positions. FIG. 24 shows a method 2400 for modifying an SF fixture based on bracket inaccuracies in accordance with several embodiments of the present technology. The method 2400 can comprise generating an SF fixture digital model (2402), where the manufactured SF digital model is used to secure the orthodontic appliance in a desired position during a shape setting procedure in which the orthodontic appliance is shape set into its as-installed configuration for moving the teeth. The SF fixture can have securing portions configured to retain attachment portions of the appliance and the positions of the securing portions can be based on the intended bracket positions (SFi). As a result, the appliance will move the patient's teeth once installed such that the attachment portions, and thereby the brackets, are located at the intended positions. FIG. 25A shows a schematic lingual view of a SFi with 4 teeth, each with one bracket secured thereto. FIG. 25B shows an ATA model representing the difference between the actual and intended positions of the bracket in one embodiment. FIG. 25C shows the resulting FTA without correction. In such embodiment, the appliance that was shape set based on the SFi fixture moves the teeth so that all of the attachment portions of the appliance are aligned as shown in SFi.

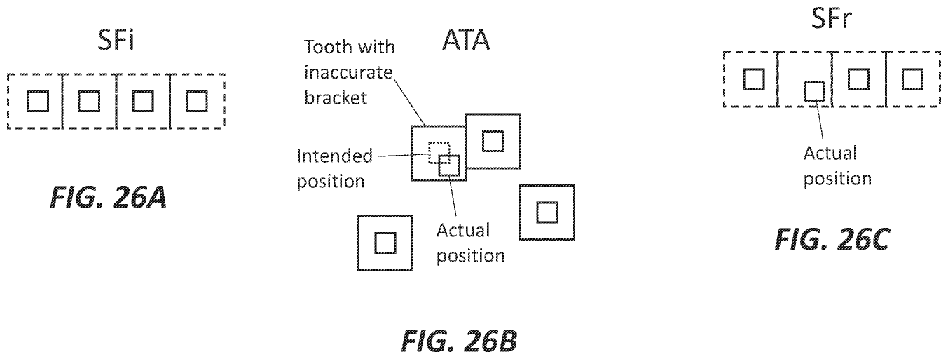

If an actual bracket position differs from an intended bracket position, the tooth in the FTA will not be aligned with the other teeth despite the brackets and attachment portions being located at the intended positions. Accordingly, it can be useful to modify an SF fixture to reflect the actual bracket positions. The system can be configured to generate a revised SF fixture (SFr) by applying the transformation characterizing a difference in the actual bracket position and the intended bracket position to the corresponding securing portion of the SF fixture. FIGS. 26A-26C schematically depict various concepts related to revising the SF fixture based on the actual bracket positions. In FIG. 26B, the actual bracket position is mesial and gingival of intended bracket position.

According to several embodiments of the present technology, when a bracket positioning error is detected by the system, the system can be configured to instruct the doctor to rebond the bracket, or the SF fixture can be remade and used to make a new appliance. In that case, tooth by tooth, the system can move the SF mold hooks by the error transformation (not the inverse). This then fixes the tooth positioning.

The various processes described herein can be partially or fully implemented using program code including instructions executable by one or more processors of a computing system for implementing specific logical functions or steps in the process. The program code can be stored on any type of computer-readable medium, such as a storage device or storage medium, which includes, for example, a disk or hard drive but does not include transitory computer-readable media. Computer-readable media containing code, or portions of code, can include any appropriate media known in the art, such as non-transitory computer-readable storage media. Computer-readable media can include volatile and non-volatile, removable and non-removable media implemented in any method or technology for storage and/or transmission of information, including, but not limited to, random-access memory (RAM), read-only memory (ROM), electrically erasable programmable read-only memory (EEPROM), flash memory, or other memory technology; compact disc read-only memory (CD-ROM), digital video disc (DVD), or other optical storage; magnetic cassettes, magnetic tape, magnetic disk storage, or other magnetic storage devices; solid state drives (SSD) or other solid state storage devices; or any other medium which can be used to store the desired information and which can be accessed by a system device.

### Conclusion

Although many of the embodiments are described above with respect to systems, devices, and methods for orthodontic treatment evaluation, the technology is applicable to other applications and/or other approaches. Moreover, other embodiments in addition to those described herein are within the scope of the technology. Additionally, several other embodiments of the technology can have different configurations, components, or procedures than those described herein. A person of ordinary skill in the art, therefore, will accordingly understand that the technology can have other embodiments with additional elements, or the technology can have other embodiments without several of the features shown and described above.

The descriptions of embodiments of the technology are not intended to be exhaustive or to limit the technology to the precise form disclosed above. Where the context permits, singular or plural terms may also include the plural or singular term, respectively. Although specific embodiments of, and examples for, the technology are described above for illustrative purposes, various equivalent modifications are possible within the scope of the technology, as those skilled in the relevant art will recognize. For example, while steps are presented in a given order, alternative embodiments may perform steps in a different order. The various embodiments described herein may also be combined to provide further embodiments.

As used herein, the terms “generally,” “substantially,” “about,” and similar terms are used as terms of approximation and not as terms of degree, and are intended to account for the inherent variations in measured or calculated values that would be recognized by those of ordinary skill in the art.

Moreover, unless the word “or” is expressly limited to mean only a single item exclusive from the other items in reference to a list of two or more items, then the use of “or” in such a list is to be interpreted as including (a) any single item in the list, (b) all of the items in the list, or (c) any combination of the items in the list. Additionally, the term “comprising” is used throughout to mean including at least the recited feature(s) such that any greater number of the same feature and/or additional types of other features are not precluded. It will also be appreciated that specific embodiments have been described herein for purposes of illustration, but that various modifications may be made without deviating from the technology. Further, while advantages associated with certain embodiments of the technology have been described in the context of those embodiments, other embodiments may also exhibit such advantages, and not all embodiments need necessarily exhibit such advantages to fall within the scope of the technology. Accordingly, the disclosure and associated technology can encompass other embodiments not expressly shown or described herein.

1. A method comprising:
creating a first digital model representing a patient's teeth in original positions, prior to an orthodontic intervention;
creating a second digital model representing the patient's teeth in planned positions, prior to the orthodontic intervention;
at a time after initiation of the orthodontic intervention, creating a third digital model representing the patient's teeth in current positions; and
displaying, via a display device, an image of the first, second, and third digital models overlaid on one another.

2. A method comprising:
creating a first digital model representing a patient's teeth in original positions with orthodontic brackets on the patient's teeth in intended positions relative to the patient's teeth;
creating a second digital model representing the patient's teeth in planned positions with the orthodontic brackets on the patient's teeth in the intended positions relative to the patient's teeth;
creating a third digital model representing the patient's teeth in current positions with the orthodontic brackets on the patient's teeth in actual positions relative to the patient's teeth; and
displaying, via a display device, an image of the first, second, and third digital models overlaid on one another.

3. A method comprising:
creating a first digital model representing a patient's teeth in original positions with orthodontic brackets on the patient's teeth in intended positions relative to the patient's teeth;
creating a second digital model representing the patient's teeth in planned positions with the orthodontic brackets on the patient's teeth in the intended positions relative to the patient's teeth;
creating a third digital model representing the patient's teeth in current positions with the orthodontic brackets on the patient's teeth in actual positions relative to the patient's teeth;
obtaining positional differences between the actual positions and the intended positions of the orthodontic brackets; and
based at least in part on the positional differences, creating a fourth digital model representing the patient's teeth in realistic planned positions with the orthodontic brackets on the patient's teeth in the actual positions relative to the patient's teeth.

4. The method of claim 3, wherein each of the positional differences between the actual positions and the intended positions of the orthodontic brackets comprises a transformation matrix.

5. The method of claim 4, wherein creating the fourth digital model comprises applying an inverse of the transformation matrix to the planned positions.

6. The method of claim 3, wherein the actual positions of the orthodontic brackets in the fourth digital model substantially correspond to the intended positions of the orthodontic brackets in the second digital model.

7. The method of claim 3, wherein obtaining each one of the positional differences comprises registering one of the patient's teeth and a respective one of the orthodontic brackets on the one of the patient's teeth from the third digital model to a corresponding one of the patient's teeth from the first digital model or the second digital model.

8. The method of claim 7, wherein registering one of the patient's teeth and the respective one of the orthodontic brackets on the one of the patient's teeth from the third digital model to the corresponding one of the patient's teeth in the first digital model or the second digital model comprises determining a transformation that, when applied to the one of the patient's teeth and the respective one of the orthodontic brackets on the one of the patient's teeth from the third digital model, reduces an error parameter characterizing a positional difference between the one of the patient's teeth from the third digital model and the corresponding one of the patient's teeth from the first digital model or the second digital model.

9. The method of claim 3, wherein obtaining each one of the positional differences comprises registering one of the patient's teeth and a respective one of the orthodontic brackets on the one of the patient's teeth from the first digital model or the second digital model to a corresponding one of the patient's teeth from the third digital model.

10. The method of claim 9, wherein registering one of the patient's teeth and the respective one of the orthodontic brackets on the one of the patient's teeth from the first digital model or the second digital model to the corresponding one of the patient's teeth in the third digital model comprises determining a transformation that, when applied to the one of the patient's teeth and the respective one of the orthodontic brackets on the one of the patient's teeth from the first digital model or the second digital model, reduces an error parameter characterizing a positional difference between the one of the patient's teeth from the first digital model or the second digital model and the corresponding one of the patient's teeth from the third digital model.

11. The method of claim 8, wherein the error parameter characterizes the positional difference between a first point on a crown of the one of the patient's teeth from the first digital model or the second digital model and a second point on the crown of the one of the patient's teeth from the third digital model.

12. The method of claim 8, wherein the error parameter characterizes the positional difference between a first point on a root of the one of the patient's teeth from the first digital model or the second digital model and a second point on the root of the one of the patient's teeth from the third digital model.

13. The method of claim 3, wherein, if one of the actual positions of one of the orthodontic brackets is more apical than a corresponding one of the intended positions of the one of the orthodontic brackets relative to a corresponding one of the patient's teeth, a corresponding one of the revised planned positions of the corresponding one of the patient's teeth is extruded relative to a corresponding one of the planned positions of the one of the patient's teeth.

14. The method of claim 3, wherein, if one of the actual positions of one of the orthodontic brackets is more occlusal than a corresponding one of the intended positions of the one of the orthodontic brackets relative to a corresponding one of the patient's teeth, a corresponding one of the revised planned positions of the corresponding one of the patient's teeth is intruded relative to a corresponding one of the planned positions of the one of the patient's teeth.

15. The method of claim 3, wherein, if one of the actual positions of one of the orthodontic brackets is more mesial than a corresponding one of the intended positions of the one of the orthodontic brackets relative to a corresponding one of the patient's teeth, a corresponding one of the revised planned positions of the corresponding one of the patient's teeth is distal relative to a corresponding one of the planned positions of the one of the patient's teeth.
